(19) United States
(12) Patent Application Publication
(10) Pub. No.: US 2007/0200479 A1
(43) Pub. Date: Aug. 30, 2007

(54) Backlight module and illuminating device

(75) Inventors: Ruey-Feng Jean, Taoyuan Hsien (TW); Kuang-Lung Tsai, Taoyuan Hsien (TW); Shih-Hsien Lin, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/641,738

(22) Filed: Dec. 20, 2006

(30) Foreign Application Priority Data
Feb. 24, 2006 (TW) 95106250

(51) Int. Cl. H01J 1/62

(52) U.S. Cl. 313/483

(57) ABSTRACT

The invention relates to a backlight module and an illuminating device. The backlight module includes the illuminating device, a first substrate, a second substrate and a coating layer. The illuminating device further includes a lamp filled with a gas and a fluorescent material coated on the surface of the lamp. The coating layer further comprises a quantum dot material.

### BACKGROUND OF THE INVENTION

1. Field of the Invention

The invention relates to a backlight module and an illuminating device. Description of the Related Art

Backlight modules are widely applied in flat panel displays (FPDs), particularly liquid crystal displays (LCDs). Backlight modules are typically disposed behind the LCD panels. Backlight modules are typically divided into two types, the direct type and the side-edge type. Since the direct type backlight modules have better light efficiency than the side-edge lighting backlight modules, the direct type backlight modules are used in large size LCD such as LCD televisions required higher brightness.

Currently, cold cathode fluorescent lamps (CCFLs) are used as the light sources in backlight modules. The luminosity theory of CCFLs is described as the following. When the lamp is driven by high voltage, electrons are discharged by the electrode in the lamp. The electrons are exposed to an electric field for generating kinetic energy. When the high speed electrons bombard the mercury molecules in the lamp, the mercury molecules release energy generated by transition from an unstable state to the originally stable state. Thus, an ultraviolet ray is emitted by the released energy. The ultraviolet ray excites the fluorescent material on the inner wall of the lamp. A visible ray with longer wavelength is emitted by the transient charging and discharging energy of the electrons of the fluorescent material.

Due to the luminous intensity and uniformity, a CCFL can be fabricated in ultra-thin and various shapes. CCFLs are widely used for background light source in LCDs, scanners, instrument panel, micro-type advertising light boxes and picture frames or others.

Three fluorescent materials which can be respectively excited by ultraviolet ray to emit red, blue and green colors are fully mixed and then coated on the inner wall of the typical CCFL. The emitted ultraviolet ray in the lamp excites the fluorescent materials and then a visible ray, e.g. red, blue and green colors, is radiated. The radiated ray emitted from each of the fluorescent materials has different spectrum region according to the material characteristics. These three colors emitted by each of the fluorescent materials are then projected through the color filters and the liquid crystal of the LCD. The number and degree of display colors, however, are limited by the fluorescent materials. The color gamut of a conventional CCFL is shown in FIG. 1. Line 1 of FIG. 1 shows the CIE 1931 chromaticity diagram defined by Commission International de I'Eclairage (CIE). Line 2 shown in FIG. 1 is the 100% color saturation range defmed by National Television System Committee (NTSC). The red, green and blue color gamut system used in typical CCFL is shown in Line 3 of the FIG. 1. Compared with the 100% color saturation defined by NTSC, Line 3 can only reach 75% color saturation. FIG. 2 is a diagram showing wave length versus intensity in a conventional CCFL, wherein the inner wall of the CCFL is coated with Y₂O₃: Eu, LaPO₄: Ce, Th and BaMg₂Al₁₆O₂₇: Eu fluorescent materials which can emit red, green, and blue colors, respectively.

Thus, a method of achieving higher color saturation without increasing lamp volume is desirable.

### BRIEF SUMMARY OF INVENTION

Therefore, to solve the aforementioned questions, an illuminating device is provided. The illuminating device is a pressurized lamp filled with an electroluminescent material. For example, the electroluminescent material is an inert gas or a gas with mercury vapor or particles. A CCFL is given as an example to the lamp according to the invention. The lamp has an inner wall, and a pair of electrodes are introduced and sealed in the two terminals of the lamp. An exterior terminal of the electrode is connected to an external conducting wire applied to an external high voltage power source.

When the external high voltage applied to the electrode, the electrode discharges electrons in the lamp. The ionized electrons are driven to accelerate by the electrical field generated between the two electrodes in the lamp. The accelerated ionization electrons and the inert gas or the mercury vapor exchange energy by collision. An ultraviolet ray is emitted by electron transition of the atoms of the inert gas or the mercury vapors form excited state to ground state.

The shape of the lamp may be slim tubular, looped, arced, polygonal, flat, and a regular or non-regular shape. The material of the lamp is glass, plastic, ceramic or a transparent material. The lamp can be a mercury vapor fluorescent lamp, an external electrode fluorescent lamp (EEFL), a cold cathode vapor fluorescent lamp (CCFL) or a gas discharge lamp.

An inner wall of the illuminating device according to the invention is coated with a mixed fluorescent material and a coating layer. A visible ray is radiated due to the ultraviolet ray exciting the fluorescent material and the coating layer.

The coating layer may comprise a quantum dot material. The electrical and the optical characteristics of the coating layer are defined by the combination of core material, crystal size and surface material of the quantum dot material. The absorption and the emission wavelength of the coating layer are defined by the various materials and particle sizes. The coating layer can comprise at least a quantum dot material such as CdTe core with CdS surface, which the crystal size is about 4.3 nm and the radiation peak is about 650 nm; CdS core with ZnS surface, which the crystal size is about 2.1 nm and the radiation peak is about 520 nm; CdSe core which the crystal size is about 2.4 nm and the radiation peak is about 520 nm; or combinations thereof. The coating layer can be fully mixed with the fluorescent materials and then coated on the inner wall of the lamp.

The invention uses the coating layer with at least a quantum dot material to define the absorption and the emission wavelength and to translate the emitted ultraviolet ray from the lamp by energy exchanging. Thus higher color saturation through color filters and a liquid crystal display can be achieved. Compared with the conventional CCFL, the color gamut of the invention is increased by 115%.

The fluorescent material comprises a powdered material which can emit red, blue, green colors or combinations thereof and is uniformly coated on the inner wall of the lamp.

The coating layer may comprise II-VI, III-V or IV-VI semiconductor nano-crystal, and can be CdSe, ZnS, CdTe, PbS, CdS, PbSe or a mixture thereof.

The coating layer can have an absorption spectrum of 300 nm-400 nm in the ultraviolet spectrum, 400 nm-700 nm in the visible spectrum or 700 nm-2500 nm in the infrared spectrum.

The backlight module of the invention comprises a first substrate, a second substrate, an illuminating device and a coating layer, wherein the second substrate is disposed opposite to the first substrate. The illuminating device is disposed between the first and second substrates. The coating layer can be coated on the first substrate, the second substrate or a lamp of the illuminating device.

The first substrate can be a reflector for reflecting rays generated by the illuminating device. The second substrate can be a diffuser to scatter reflected rays into uniform rays.

In the backlight module of the invention, the coating layer can be coated on the second substrate, coated on the first substrate or the second substrate, or coated on the inner wall or outer wall of the lamp. The coating layer comprises the quantum dot materials having different materials and dimensions.

The backlight module and the illuminating device of the invention can be individually designed to meet various user requirements and changed to the color gamut as desired. The backlight module and the illuminating device of the invention have improved color gamut, and increased color saturation. Thus, displayed colors of the LCD installed with the backlight module and the illuminating device of the invention are much bright and vivid than that of conventional LCD so that the quality of displayed images is sharper and the clarity is improved.

### BRIEF DESCRIPTION OF DRAWINGS

The invention can be more fully understood by reading the subsequent detailed description and examples with references made to the accompanying drawings, wherein:

FIG. 1 shows the color gamut of a conventional CCFL in comparison with those defined by the CIE 1931 and the NTSC;

FIG. 2 is a diagram showing wave length versus intensity in a conventional CCFL;

FIG. 3 is a schematic representation of an illuminating device of the invention;

FIG. 4 shows a cross section taken along A-A′ line in FIG. 3 of the illuminating device of the invention;

FIG. 5 is a diagram showing wave length versus intensity of the illuminating device of the invention;

FIG. 6 shows the color gamut of the illuminating device of the invention in comparison with that defined by the NTSC;

FIG. 7 shows a cross section taken along A-A′ line in FIG. 3 of the illuminating device of the invention; and

FIGS. 8-15 show cross sections of the backlight module of the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

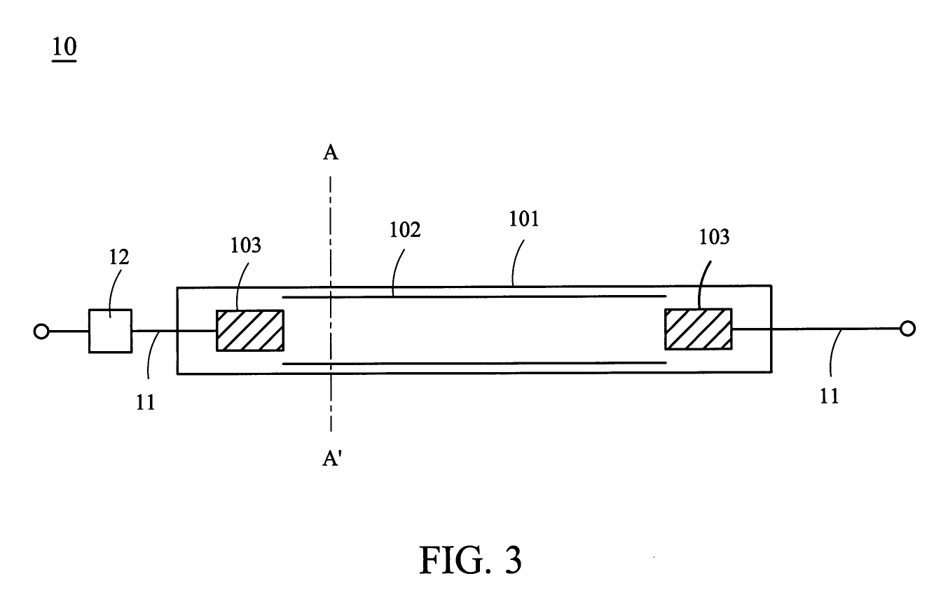

FIG. 3 is a schematic representation of an illuminating device of the invention. An illuminating device 10 is a pressurized lamp 101 filled with an electroluminescent material. For example, the electroluminescent material is formed by an inert gas or a gas with mercury vapor or particles. A cold cathode fluorescent lamp (CCFL) is given as an example to the lamp 101 of the invention. The lamp 101 has an inner wall 102, and a pair of metal electrodes 103 are introduced and sealed in the two terminals of the lamp 101. An end of the metal electrode 103 is connected to an external conducting wire 11 and an external high voltage power source 12. When the external high voltage power source 12 drives the metal electrode 103, the metal electrode 103 discharges in the lamp 101. The ionized electrons are driven to accelerate by the electrical field generated between the two electrodes in the lamp. The accelerated ionization electrons and the inert gas or the mercury vapors exchange energy by collision. An ultraviolet ray is emitted by electron transition of the atoms of the inert gas or the mercury vapors from excited state to ground state.

The shape of the lamp 101 may be rectangular, looped, arced, polygonal, flat, and a regular or non-regular shape. The material of the lamp 101 is selected from glass or transparent materials such as plastic or ceramics. The lamp 101 can be a mercury vapor fluorescent lamp, an external electrode fluorescent lamp (EEFL), a cold cathode vapor fluorescent lamp (CCFL) or a gas discharge lamp.

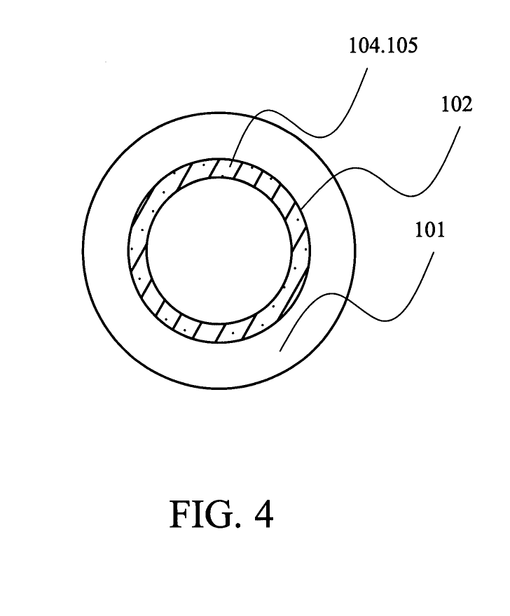

FIG. 4 shows a cross section taken along A-A′ line in FIG. 3 of the illuminating device 10 of the invention, wherein an inner wall 102 is coated with a mixed fluorescent material 104 and a coating layer 105. A visible ray is radiated since of the fluorescent material 104 and the coating layer 105 excited by the ultraviolet ray.

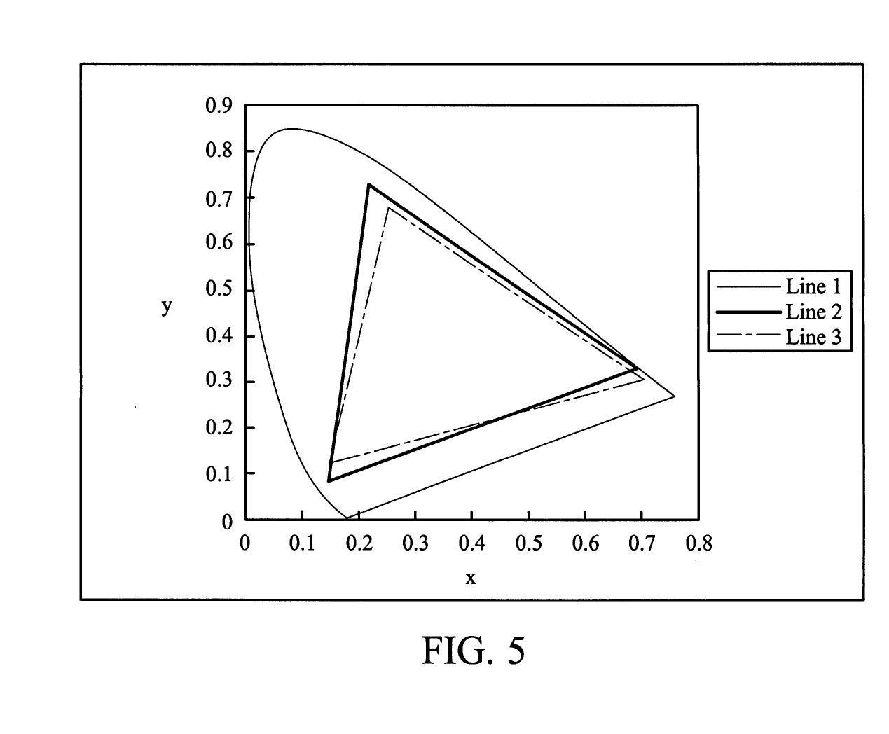

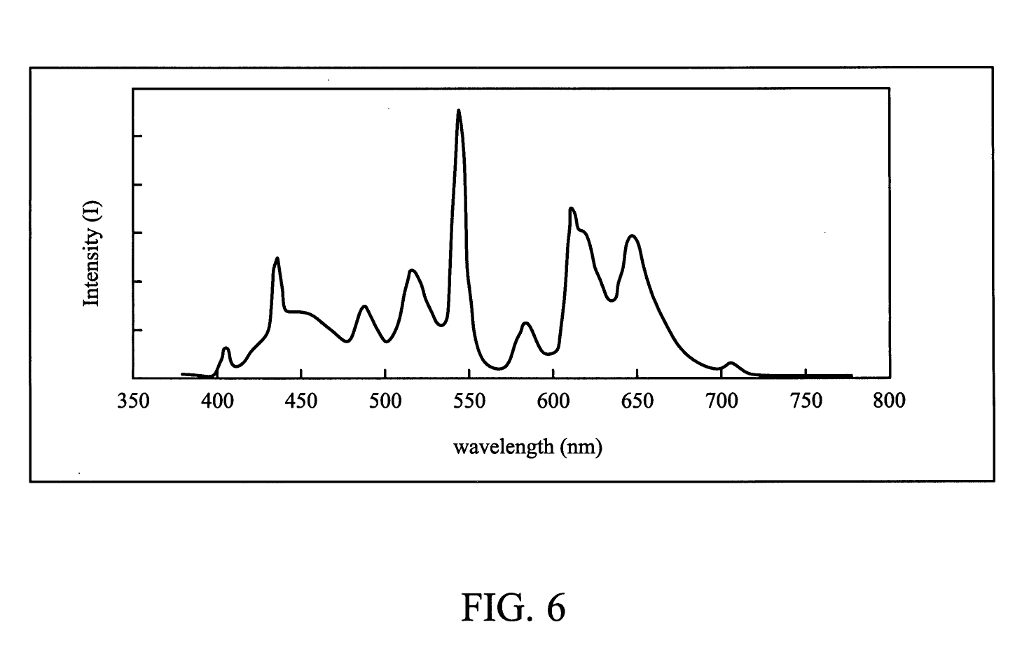

The coating layer 105 can comprise at least one quantum dot material. The electrical and the optical characteristics of the coating layer 105 are determined by the combination of materials, crystal size and surface material of the quantum dot materials. The absorption and the emission wavelength of the coating layer 105 are determined by the various materials and particle sizes. The coating layer 105 can comprise at least a quantum dot material such as CdTe core with CdS surface, which the crystal size is about 4.3 nm and the radiation peak is about 650 nm; CdS core with ZnS surface, which the crystal size is about 2.1 nm and the radiation peak is about 520 nm; CdSe core which the crystal size is about 2.4 nm and the radiation peak is about 520 nm; or combinations thereof. The coating layer 105 is fully mixed with the fluorescent material 104 and then coated on the inner wall 102 of the lamp 101. FIG. 5 is a diagram showing wavelength versus intensity of the illuminating device of the invention. FIG. 6 shows a color gamut of the illuminating device of the invention in comparison with those defined by the CIE 1931 and the NTSC.

As shown in FIG. 5, in some embodiments of the invention, the coating layer which having a quantum dot material is used to determine the absorption and the emission wavelength and to transfer the emitted ultraviolet ray from the lamp 101 by energy exchanging. Thus high color saturation through color filters and a liquid crystal display system can be achieved.

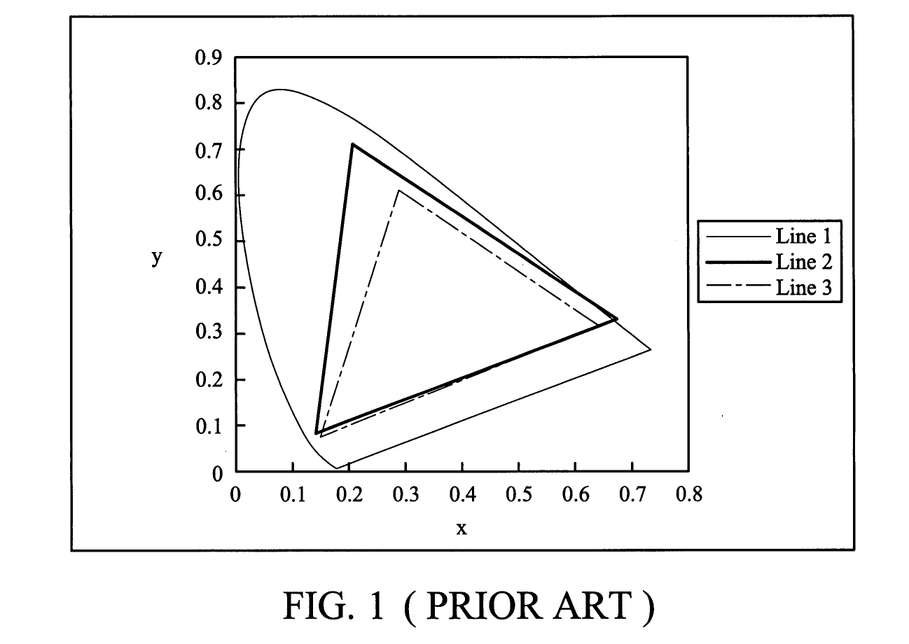

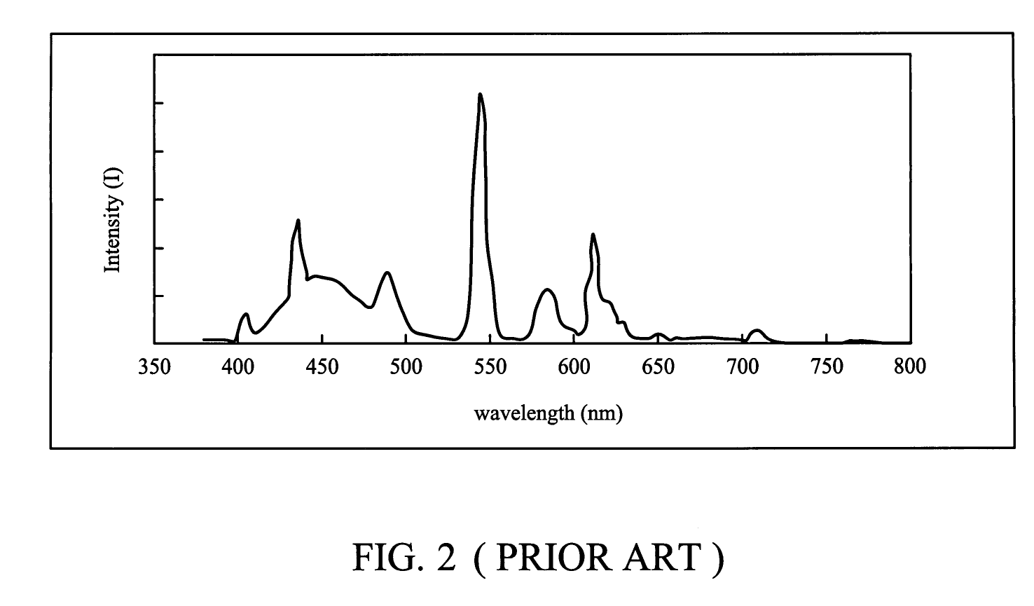

In FIG. 6, Line 1 is a color gamut defined by NTSC. Line 2 is 100% color saturation defined by NTSC. Line 3 is a color saturation of the invention. 86% color saturation can be achieved in the invention. Compared with the conventional CCFL (as to Line 3 in FIG. 1), the color gamut of the invention is increased by 115%.

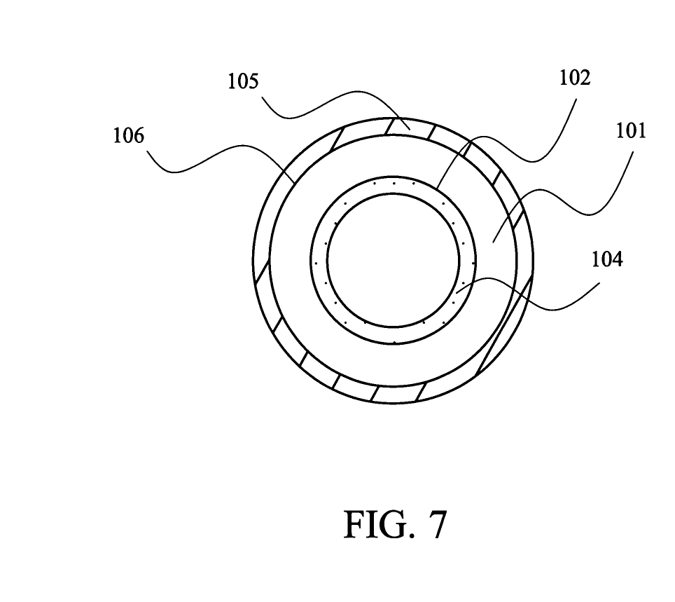

The coating layer 105 can also be coated on an outer wall 106 of the lamp 101 also as shown in FIG. 7.

The fluorescent material 104 comprises a powdered material which can emit red, blue, green colors or combinations thereof and is uniformly coated on the inner wall 102.

The coating layer 105 may comprise II-VI, III-V or IV-VI semiconductor nano-crystal, and can be CdSe, ZnS, CdTe, PbS, CdS, PbSe or a mixture thereof.

The coating layer 105 may have an absorption spectrum of a 300 nm-400 nm ultraviolet spectrum, a 400 nm-700 nm visible spectrum or a 700 nm-2500 nm infrared spectrum.

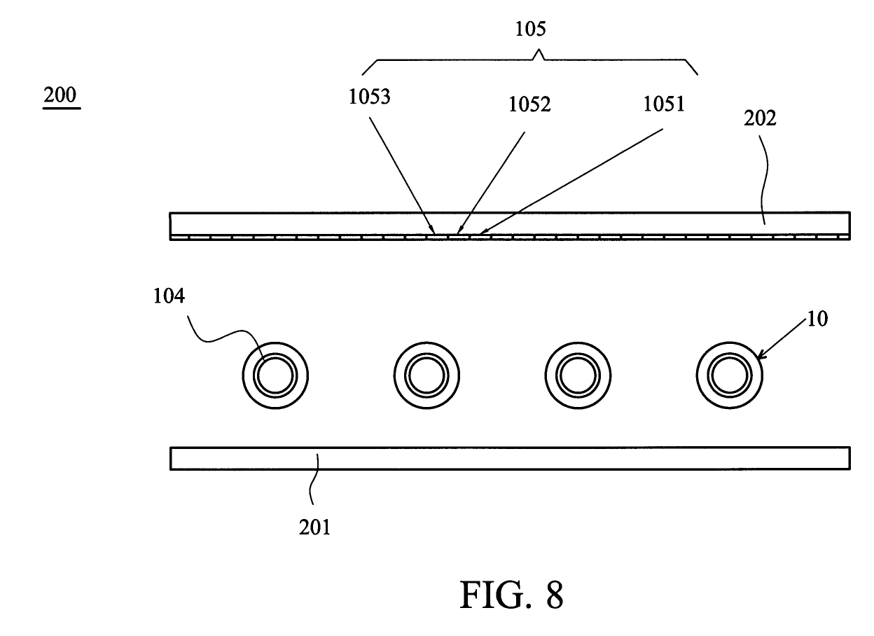

FIGS. 8 is a diagram, showing a backlight module 200 of the invention. The same or the similar devices of this embodiment and aforementioned embodiments share the same reference numbers. The backlight module 200 comprises a first substrate 201, a second substrate 202, an illuminating device 10 and a coating layer 105, wherein the second substrate 202 is disposed oppose the first substrate 201. The illuminating device 10 is disposed between the first substrate 201 and the second substrate 202. The coating layer 105 can be coated on the first substrate 201, the second substrate 202 or a lamp 101 of the illuminating device 10.

The first substrate 201 can be a reflector for reflecting rays generated by the illuminating device 10. The second substrate 202 can be a diffuser to scatter reflected rays into uniform rays.

The coating layer 105 is coated on a surface of the second substrate 202. The coating layer 105 further comprises a quantum dot material 1051 of CdTe core with CdS surface, which the crystal size is about 4.3 nm and the radiation peak is about 650 nm; a quantum dot material 1052 of CdS core with ZnS surface, which the crystal size is about 2.1 nm and the radiation peak is about 520 nm; and a quantum dot material 1053 of CdSe core which the crystal size is about 2.4 nm and the radiation peak is about 520 nm. The quantum dot materials 1051, 1052 and 1053 are coated on the surface of the second substrate 202 in sequence.

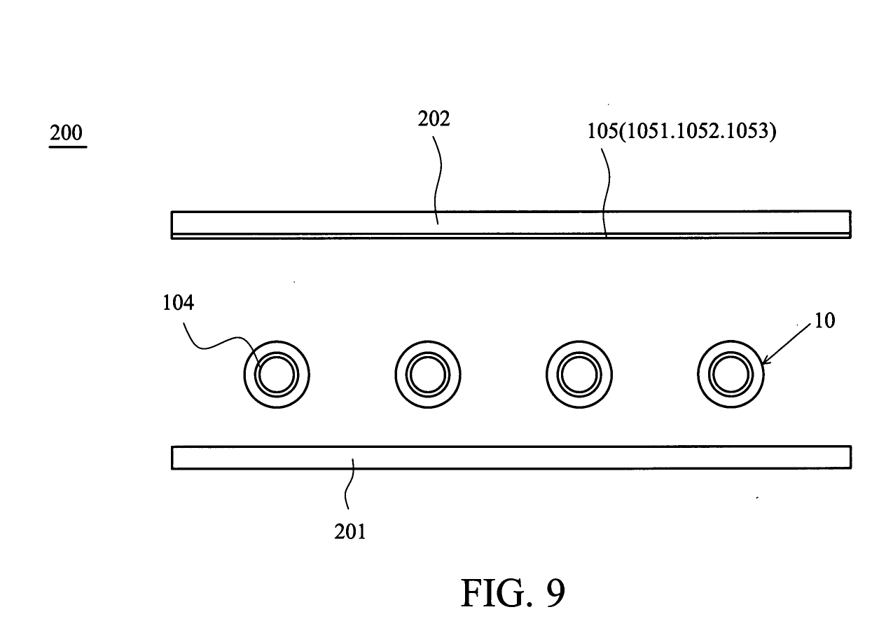

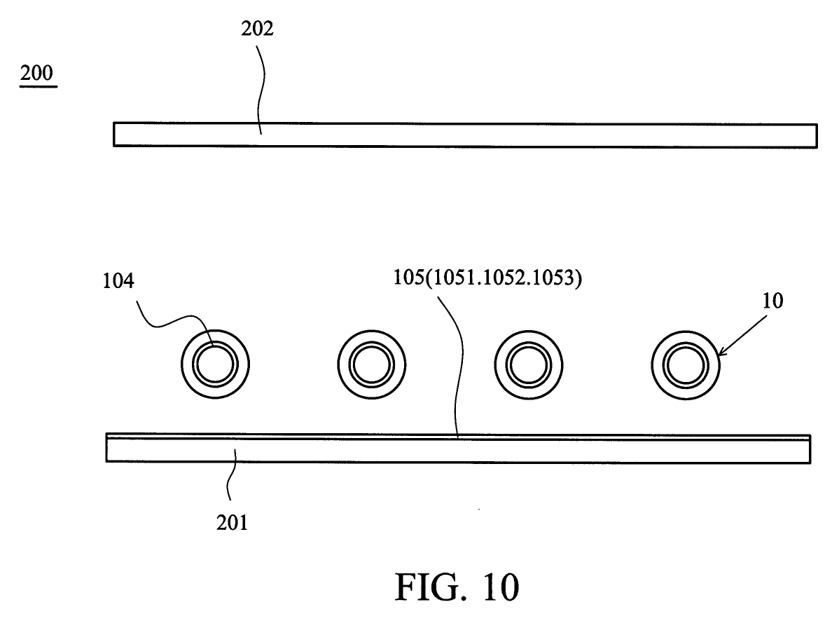

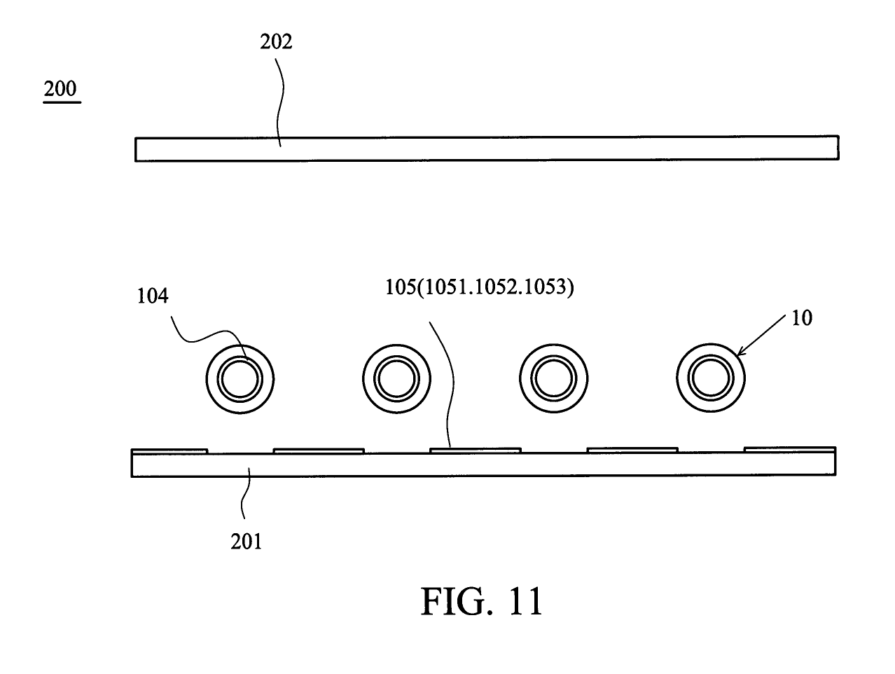

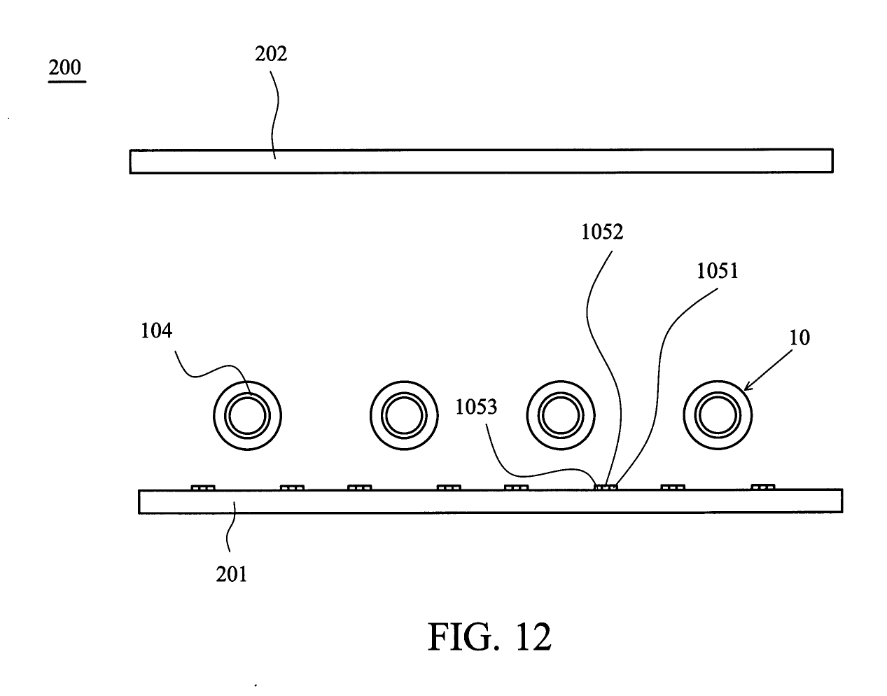

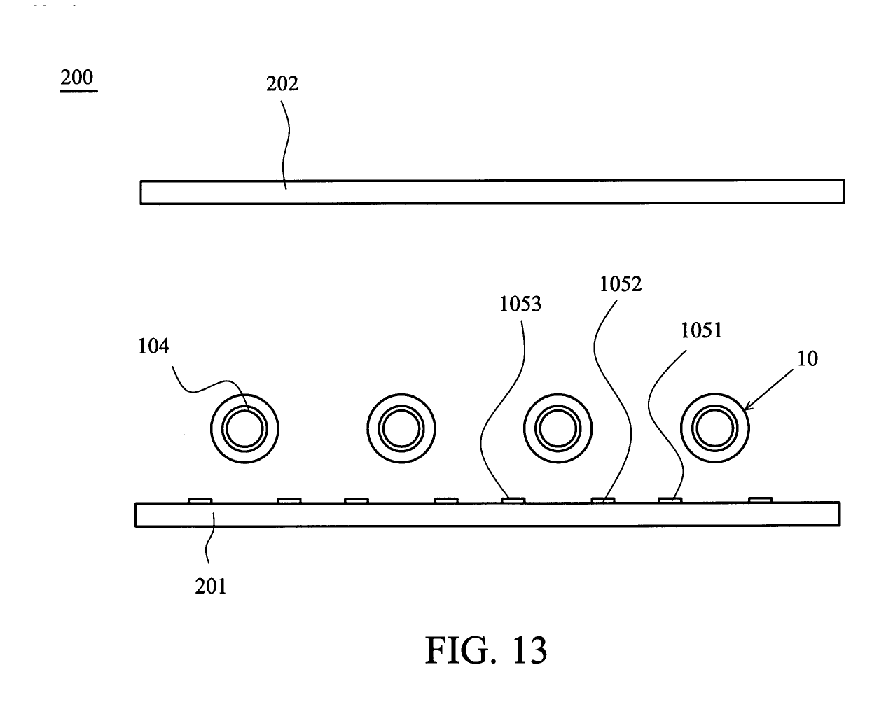

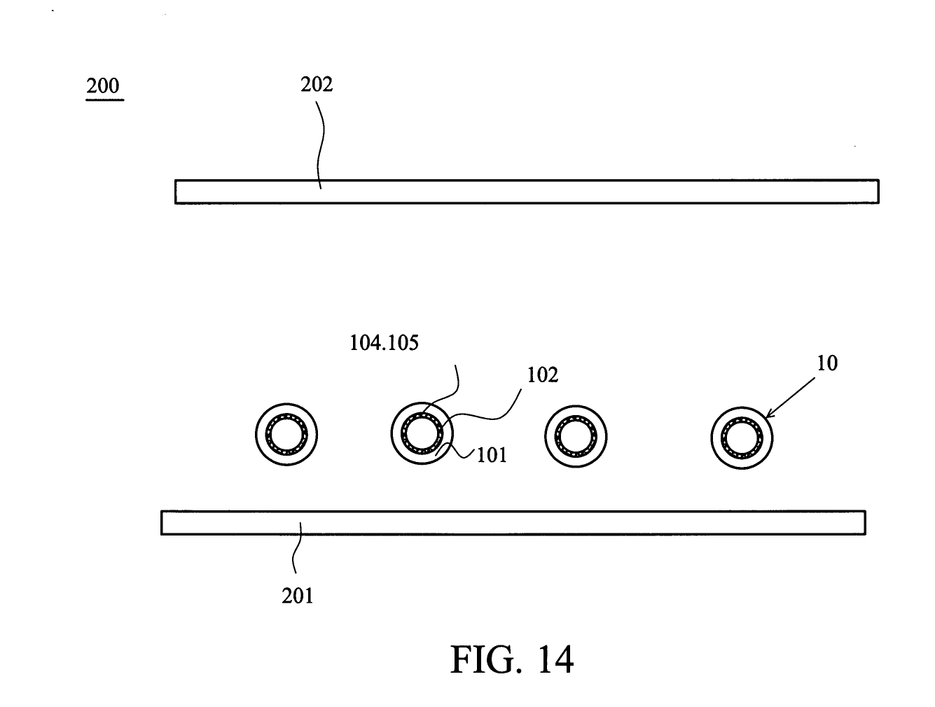

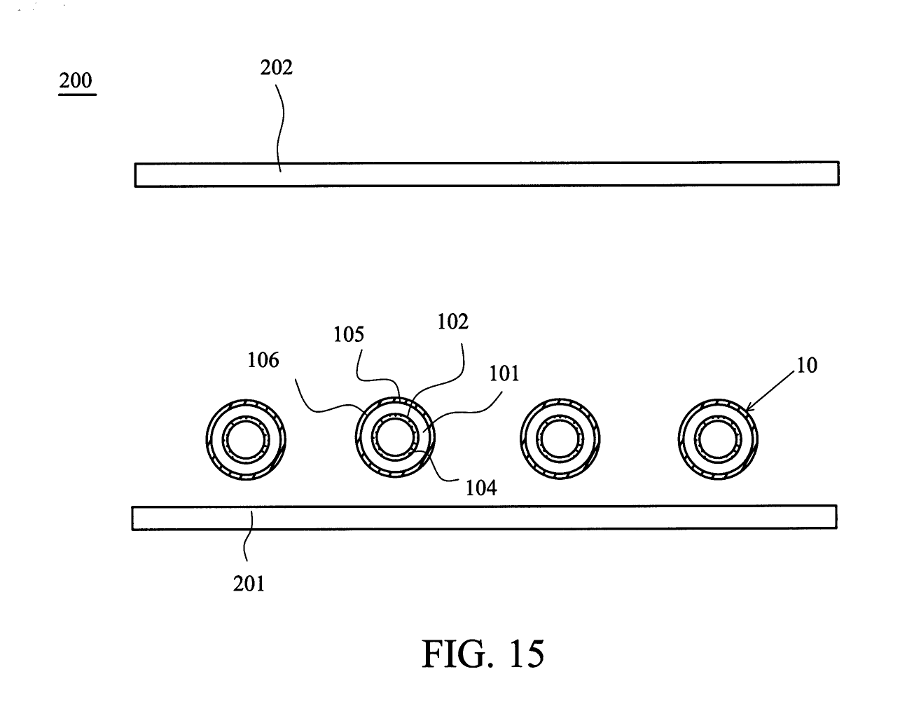

The coating layer 105 is also as shown in FIG. 9. The quantum dot materials 1051, 1052 and 1053 are coated on the surface of the second substrate 202 after mixing. Alternately, as shown in FIG. 10, the coating layer 105 is fully coated on a surface of the first substrate 201. In other embodiments, as shown in FIG. 11, the coating layer 105 is partially coated on the surface of the first substrate 201. Alternately, as shown in FIG. 12, the quantum dot materials 1051, 1052 and 1053 are partially coated on the surface of the first substrate 201 and the quantum dot materials 1051, 1052 and 1053 are in the vicinity to each other. In other embodiments, as shown in FIG. 13, each of the quantum dot materials 1051, 1052 and 1053 are partially coated on the surface of the first substrate 201. Alternately, as shown in FIG. 14, the coating layer 105 is coated on an inner wall 102 of the lamp 101 of the illuminating device 10. In other embodiments, as shown in FIG. 15, the coating layer 105 is coated on an outer wall 106 of the lamp 101 of the illuminating device 10.

The backlight module and the illuminating device of the invention can be individually designed to meet various user requirements and changed to the required color gamut to increase user convenience. The backlight module and the illuminating device of the invention has improved color gamut, and increased color saturation. Thus, displayed colors are more bright and vivid and the quality of displayed images is sharper and clarity is improved.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An illuminating device, comprising:
a lamp filled with a gas;
a fluorescent material coated on an inner wall of the lamp; and
a coating layer having at least a quantum dot material, wherein the coating layer is coated on the inner wall or an outer wall of the lamp.

2. The illuminating device as claimed in claim 1, wherein the gas comprises an inert gas, a gas with mercury vapor or particles, or an electroluminescent material.

3. The illuminating device as claimed in claim 1, wherein the lamp comprises glass, plastic, ceramic or a transparent material.

4. The illuminating device as claimed in claim 1, wherein the lamp is a rectangular, looped, arced, polygonal, flat, regular or non-regular shape.

5. The illuminating device as claimed in claim 1, wherein the lamp is a mercury vapor fluorescent lamp, an external electrode fluorescent lamp (EEFL), a cold cathode vapor fluorescent lamp (CCFL) or a gas discharge lamp.

6. The illuminating device as claimed in claim 1, wherein the fluorescent material comprises a powdered material which can emit red, blue, or green color rays, excited by ultraviolet ray.

7. The illuminating device as claimed in claim 1, wherein the quantum dot material comprises II-VI, III-V or IV-VI semiconductor nano-crystal.

8. The illuminating device as claimed in claim 1, wherein the quantum dot material is CdSe, ZnS, CdTe, PbS, CdS, PbSe or a mixture thereof.

9. The illuminating device as claimed in claim 1, wherein the quantum dot material has an absorption spectrum of a 300 nm-400 nm ultraviolet spectrum, a 400 nm-700 nm visible spectrum or a 700 nm-2500 nm infrared spectrum.

10. A backlight module, comprising:
a first substrate;
a second substrate disposed opposite to the first substrate;
an illuminating device placed between the first and second substrates and comprising:
a lamp filled with a gas; and
a fluorescent material coated on an inner wall of the lamp; and
a coating layer having at least a quantum dot material, wherein the coating layer is coated on the first substrate, the second substrate or the lamp.

11. The backlight module as claimed in claim 10, wherein the first substrate and the second substrate are a diffuser and a reflector, respectively.

12. The backlight module as claimed in claim 10, wherein the coating layer is partially or fully coated on the first substrate or the second substrate.

13. The backlight module as claimed in claim 10, wherein the gas comprises an inert gas, a gas with mercury vapor or particles, or an electroluminescent material.

14. The backlight module as claimed in claim 10, wherein the lamp is a mercury vapor fluorescent lamp, an external electrode fluorescent lamp (EEFL), a cold cathode vapor fluorescent lamp (CCFL) or a gas discharge lamp.

15. The backlight module as claimed in claim 10, wherein the fluorescent material comprises a powdered material which can emit red, blue, or green color rays, excited by ultraviolet ray.

16. The backlight module as claimed in claim 10, wherein the quantum dot material comprises II-VI, III-V or IV-VI semiconductor nano-crystal.

17. The backlight module as claimed in claim 10, wherein the quantum dot material is CdSe, ZnS, CdTe, PbS, CdS, PbSe or a mixture thereof.

18. The backlight module as claimed in claim 10, wherein the quantum dot material has an absorption spectrum of a 300 nm-400 nm ultraviolet spectrum, a 400 nm-700 nm visible spectrum or a 700 nm-2500 nm infrared spectrum.

19. The backlight module as claimed in claim 10, wherein the coating layer comprises a plurality of quantum dot materials coated on the first substrate or the second substrate in sequence or after mixing, and each of the quantum dot materials has different materials and dimensions.

20. The backlight module as claimed in claim 10, wherein the coating layer is coated on the inner wall or outer wall of the lamp.
